(19) United States
(12) Patent Application Publication
(10) Pub. No.: US 2010/0321228 A1
(43) Pub. Date: Dec. 23, 2010

(54) RADAR DETECTOR

(75) Inventor: Go Min-Ho, Incheon (KR)

Correspondence Address: AMSTER, ROTHSTEIN & EBENSTEIN LLP, 90 PARK AVENUE, NEW YORK, NY, 10016, US

(73) Assignee: RADIX. INC., Seoul (KR)

(21) Appl. No.: 12/821,841

(22) Filed: Jun. 23, 2010

(30) Foreign Application Priority Data
Jun. 23, 2009 (KR) 10-2009-0055931

(51) Int. Cl. G01S 7/42

(52) U.S. Cl. 342/20

(57) ABSTRACT

A radar detector is provided including a microwave module, which converts a UHF signal to a RF signal, a RF module, which converts the RF signal to an IF signal, a demodulator, which demodulates the IF signal, and a signal processing controller, which receives a signal demodulated by the demodulator and performs an appropriate control for each constituting component. The microwave module includes an antenna, which receives a UHF signal, a first local oscillating unit, which includes an oscillator and a buffer amplifier, and a first mixing unit, which converts a signal received from the antenna to an RF signal. The first local oscillating unit is supplied with power by a single bias circuit.

### CROSS-REFERENCE TO RELATED APPLICATIONS

This application claims the benefit of Korean Patent Application No. 10-2009-0055931, filed with the Korean Intellectual Property Office on Jun. 23, 2009, the disclosure of which is incorporated herein by reference in its entirety.

### FIELD OF THE INVENTION

The present invention is related to a radar detector, more specifically to a single bias circuit having an active bias circuit that can implement a small, low-cost multi-stage voltage control oscillator and a small, low-cost amplifier being used in a radar detector.

### BACKGROUND OF THE INVENTION

For a safe road traffic, there have been many efforts worldwide to prevent traffic accidents by introducing many safety features, for example, a safety alarm transmitter for alerting road conditions and a speed meter using microwaves and laser.

In the United States, the use of a speed meter, a signal detector and the like is legal, and many countries are increasingly following this trend.

A radar detector, which is a kind of the signal detector, is a system that notifies a motorist through an alarm sound, voice or display by detecting an ultra high frequency (“UHF”) signal or laser beam sent by a speed gun to monitor his/her driving speed.

For this purpose, the radar detector uses the X-band (10.525±0.05 GHz), the KU-band (13.45±0.05 GHz), the K-band (24.150±0.125 GHz) and the Ka-band (34.7 GHz±1.3 GHz), which are segments of the microwave radio region of the electromagnetic spectrum.

The radar detector includes an antenna, an oscillator, an amplifier, a mixer, a filter and the like. Here, an appropriate drain current and an appropriate gate current need to be supplied to each active component of the oscillator and the amplifier in order to operate the active components included in the oscillator and the amplifier. Accordingly, a plurality of bias circuits are used in order to supply an appropriate drain current and gate current to each active component. Also, if a multi-stage oscillator and a multi-stage amplifier are used, the number of active components included in the multi-stage oscillator and the multi-stage amplifier is increased, thereby proportionally increasing the number of bias circuits.

Since a number of bias circuits are needed for supplying an appropriate voltage and current to each active component, the surface area of the circuit needs to be increased. Also, since the number of active components is increased, the production cost may be increased.

As described above, it is quite difficult to implement a small, simple and low-cost product since a number of bias circuits are used for supplying an appropriate operating voltage to a multi-stage circuit used in the conventional radar detector.

### SUMMARY OF THE INVENTION

The present invention provides a single bias circuit that can set several operating voltages for a multi-stage circuit by using a single bias circuit, in order to solve the problems caused by using a number of bias circuits to supply an appropriate operating voltage to a multi-stage circuit used in a radar detector.

The present invention also provides a small, low-cost single bias circuit.

Furthermore, the present invention provides a small, low-cost radar detector by using the single bias circuit.

An aspect of the present invention provides a radar detector. The radar detector in accordance with an embodiment of the present invention can include a microwave module, which converts a UHF signal to a radio frequency (“RF”) signal, an RF module, which converts the RF signal to an intermediate frequency (“IF”) signal, a demodulator, which demodulates the IF signal, and a signal processing controller, which receives a signal demodulated by the demodulator and performs an appropriate control for each constituting component. Here, the microwave module can include an antenna, which receives a UHF signal, a first local oscillating unit, which includes an oscillator and a buffer amplifier, and a first mixing unit, which converts a signal received from the antenna to an RF signal. The first local oscillating unit can be supplied with power by a single bias circuit.

The RF module can include a multi-stage amplifying unit, which has a single bias circuit for amplifying an RF signal, a second mixing unit, which converts the RF signal amplified by the multi-stage amplifying unit to an IF signal, a second local oscillating unit, which generates a frequency signal required for the second mixing unit, and a filter, which extracts a specific band signal of the IF signal converted by the second mixing unit.

The oscillator and the buffer amplifier constituting the first local oscillating unit can be supplied with a voltage by a single bias circuit. Also, the multi-stage amplifying unit can be constituted by at least two amplifiers, each of which is supplied with a voltage by a single bias circuit.

The single bias circuit can include an external power source, which is supplied with positive power and negative power from the outside, a capacitor, which removes noise generated by the external power source, and a resistor.

Some resistance among at least one resistor constituting the single bias circuit can set the positive power and the negative power supplied from the external power source as each respective voltage required for operation of the first local oscillating unit, the multi-stage amplifying unit and the second local oscillating unit.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an example showing a radar detector.

FIG. 2A is a schematic diagram of a bias circuit employed in a first local oscillating unit in accordance with the related art.

FIG. 2B is a schematic diagram of a bias circuit employed in a multi-stage amplifying unit in accordance with the related art.

FIG. 3 is a schematic diagram of a first local oscillating unit with a single bias circuit in accordance with an embodiment of the present invention.

FIG. 4 is a schematic diagram of a single bias circuit in accordance with an embodiment of the present invention.

FIG. 5 is a schematic diagram of a single bias circuit employed in a first local oscillating unit in accordance with an embodiment of the present invention.

### DETAILED DESCRIPTION

The features and advantages of this invention will become apparent through the below drawings and description.

A radar detector having a multi-stage voltage control oscillator and a multi-stage amplifier in a single bias circuit in accordance with a certain embodiment of the present invention will be described below in more detail with reference to the accompanying drawings. Those components that are the same or are in correspondence are rendered the same reference numeral regardless of the figure number, and redundant descriptions are omitted.

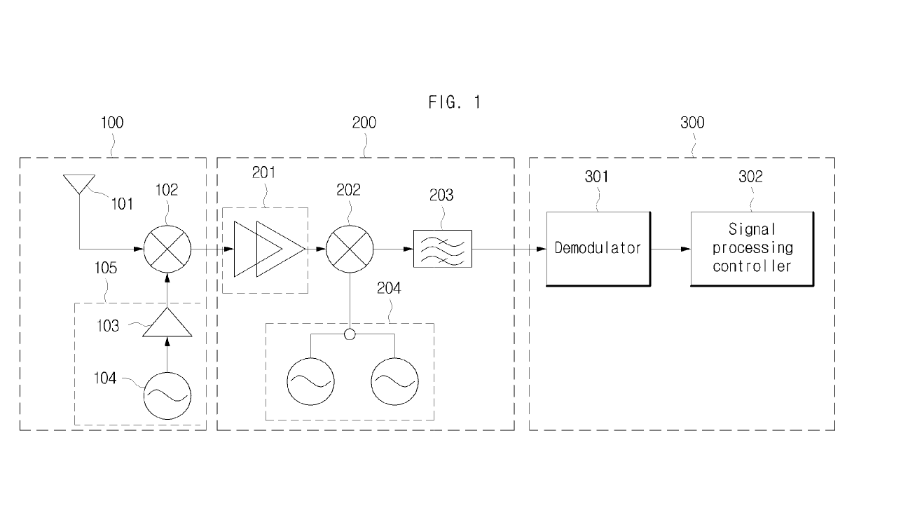

FIG. 1 is an example showing a radar detector.

Referring to FIG. 1, a radar detector is constituted by a microwave module 100, which converts a UHF signal to an RF signal, an RF module 200, which converts the RF signal to an IF signal, and a baseband module 300, which demodulates the converted IF signal and performs signal processing.

The microwave module 100 is constituted by an antenna 101, which is for receiving UHF signals, a first local oscillating unit 105, which is constituted by an oscillator 104 and a buffer amplifier 103 so as to generate a signal having a sufficient amplitude and an appropriate frequency, and a first mixing unit 102, which converts signals received from the antenna 101 to RF signals by mixing with a frequency generated by the first local oscillating unit 105.

The RF module 200 is constituted by a two-stage amplifying unit 201, which is for amplifying the RF signals converted by the first mixing unit 102, a second mixing unit 202, which converts the amplified RF signals to IF signals, a second local oscillating unit 204, which generates frequency signals required for the second mixing unit 202, and a second filter 203, which is for obtaining a specific band of the IF signals among the output signals converted by the second mixing unit 202.

The baseband module 300 is constituted by a demodulator 301, which is for demodulating the IF signals filtered to a specific band by the second filtering unit 203, and a signal processing controller 302, which receives and processes the demodulated signals and performs an appropriate control of each constituting component.

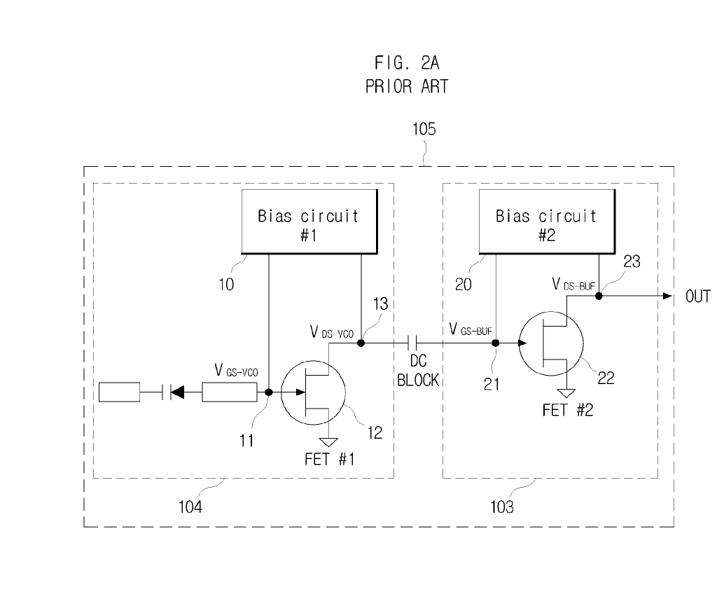

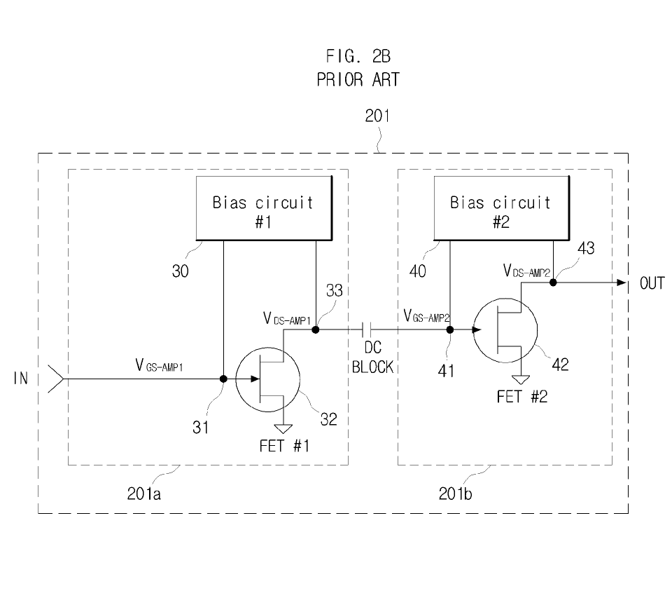

FIGS. 2A and 2B show schematic diagrams of conventional bias circuits for supplying an appropriate voltage and an appropriate current to the first local oscillating unit 105, which is constituted by the oscillator 104 and the buffer amplifier 103, and the two-stage amplifying unit 201.

FIG. 2A is a schematic diagram of a bias circuit employed in a first local oscillating unit in accordance with the related art.

FIG. 2A is a diagram for describing bias circuits employed in the conventional multi-stage first local oscillating unit 105, in which a bias circuit 10 that supplies a gate voltage 11 and a drain voltage 13 to an active component 12 of the oscillator 104 and a bias circuit 20 that supplies a gate voltage 21 and a drain voltage 23 to an active component 22 of the buffer amplifier 103 are included.

FIG. 2B is a schematic diagram of a bias circuit employed in a multi-stage amplifying unit in accordance with the related art.

FIG. 2B is a diagram for describing bias circuits employed in the conventional multi-stage amplifying unit 201, in which a bias circuit 30 that supplies a gate voltage 31 and a drain voltage 33 to an active component 32 of a first amplifier 201a and a bias circuit 40 that supplies a gate voltage 41 and a drain voltage 43 to an active component 42 of a second amplifier 201b are included.

As illustrated in FIGS. 2A and 2B, in which the first local oscillating unit 105 and the two-stage amplifying unit 201 are implemented in accordance with the related art, a plurality of bias circuits 10, 20, 30 and 40 are needed in order to supply the appropriate gate voltages 11, 21, 31 and 41 and drain voltages 13, 23, 33 and 43 to the active components 12, 22, 32 and 42, respectively. Since a plurality of bias circuits are needed to supply an appropriate voltage and current to each active component, the size of the circuit needs to be increased, and the production cost becomes high.

To solve this problem, a dedicated integrated circuit can be used. Nevertheless, use of a dedicated integrated circuit is hampered by the high cost.

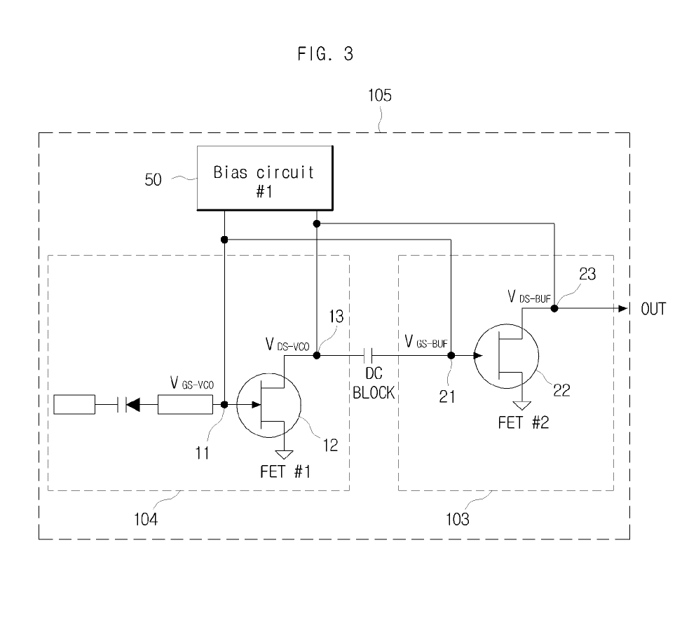

FIG. 3 is a schematic diagram of a first local oscillating unit with a single bias circuit in accordance with an embodiment of the present invention.

The first local oscillating unit 105 shown in FIG. 3 can be constituted by a single bias circuit 50, the oscillator 104 and the buffer amplifier 103.

Referring to FIG. 3, the single bias circuit 50 supplies gate voltages 11 and 21 and drain voltages 13 and 23 for operating the oscillator 104 and the buffer amplifier 103.

In the conventional technology, the gate voltages 11 and 21 and the drain voltages 13 and 23, which are needed for the proper operation of the active components 12 and 22 constituting the oscillator 104 and the buffer amplifier 103, may be different from one another. Therefore, each active component needs separate bias circuits supplying a gate voltage and a drain voltage, respectively, in order to operate each active component properly.

Like using the single bias circuit 50 in accordance with an embodiment of the present invention in the first local oscillating unit 105, the oscillator 104 and the buffer amplifier 103 in FIG. 3, the single bias circuit 50 in accordance with an embodiment of the present invention can also be used in the multi-stage amplifying unit 201 shown in FIG. 1. Specifically, the multi-stage amplifying unit 201 is constituted by at least two amplifiers, each of which can be supplied with a voltage by the single bias circuit 50.

As such, at least one oscillator constituting the second local oscillating unit 204 shown in FIG. 1 can also be supplied with a voltage by the single bias circuit 50.

Also, the first local oscillating unit 105, the multi-stage amplifying unit 201 and the second local oscillating unit 204 can be supplied with a voltage by the single bias circuit 50.

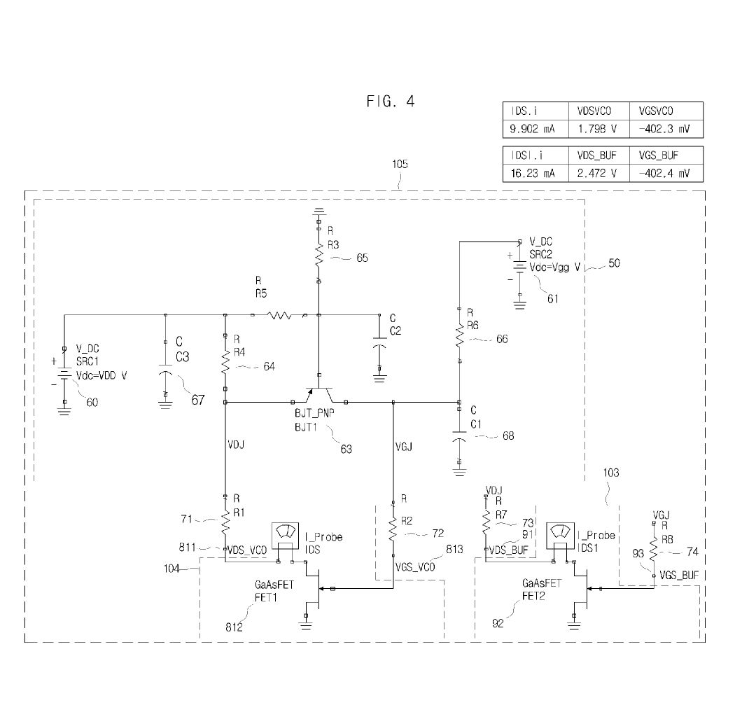

FIG. 4 is a schematic diagram of a single bias circuit in accordance with an embodiment of the present invention.

Referring to FIG. 4, the single bias circuit 50 can be constituted by external power sources 60 and 61, an active component 63, first resistors 64, 65 and 66, capacitors 67 and 68 and second resistors 71, 72, 73 and 74. That is, the single bias circuit 50 can be constituted by an external power source, which is supplied with negative power and positive power from the outside, a capacitor, which removes noise generated by the external power source, and a resistor.

The first resistors 64, 65 and 66 receive the positive power source 60 and the negative power source 61 supplied from the outside and set as a voltage that is appropriate for the operation of the active component 63. Here, the resistor R4 64 sets an emitter voltage, the resistor R3 65 sets a base voltage, and the resistor R6 66 sets a collector voltage, for the active component 63.

The capacitors 67 and 68 are for removing the noise generated by the external power sources 60 and 61. The capacitor C3 67 removes the noise generated by the positive power source 60, and the capacitor C1 68 removes the noise generated by the negative power source 61.

The second resistors 71, 72, 73 and 74 control gate voltages and drain voltages required for each active component used in a multi-stage circuit. The resistor R1 71 sets a drain voltage for a first active component, and the resistor R2 72 sets a gate voltage for the first active component, in the multi-stage circuit. The resistor R3 73 sets a drain voltage for a second active component, and the resistor R4 74 sets a gate voltage for the second active component, in the multi-stage circuit.

Here, the number of active components is not restricted and can be increased or decreased in accordance with the required design conditions and specifications of a circuit and a product. Accordingly, the number of resistors controlling drain voltages or gate voltages being supplied to the active components can also be proportionally increased or decreased in accordance with the number of the active components.

Furthermore, the active component that is supplied with a voltage by the single bias circuit 50 can be any active component included in the first local oscillating unit 105, the multi-stage amplifying unit 201 and the second local oscillating unit 204.

In other words, some resistance among at least one resistor constituting the single bias circuit 50 can set the positive power and the negative power supplied from the external power sources 60 and 61 to each voltage required for operating the first local oscillating unit 105, the multi-stage amplifying unit 201 and the second local oscillating unit 204, respectively.

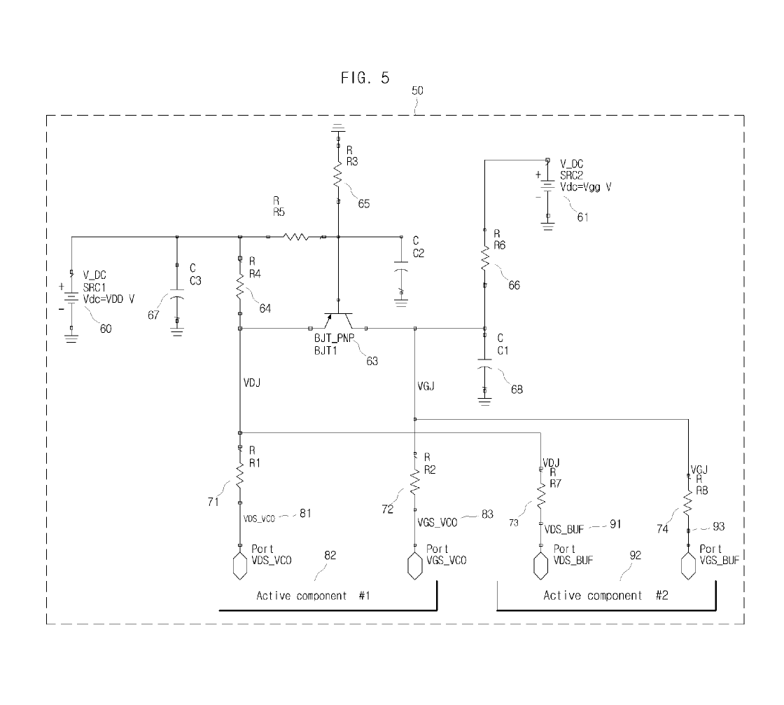

FIG. 5 is a schematic diagram of a single bias circuit employed in a first local oscillating unit in accordance with an embodiment of the present invention.

Referring to FIG. 5, the single bias circuit 50 designed in accordance with an embodiment of the present invention supplies voltages that are appropriate for the operation of active components 82 and 92 of the oscillator 104 and the buffer amplifier 103 constituting the first local oscillating unit 105.

A drain voltage (VDS_VCO) 81 for the first active component 82, which is an active component of the oscillator 104, is set to be about 1.8V (1.798V) by the resistor R1 71, which is a resistor of the single bias circuit 50, and a gate voltage (VGS_VCO) 83 for the first active component 82 is set to be about −0.4V (−402.3 mV) by the resistor R2 72, which is a resistor of the single bias circuit 50. Then, the drain voltage (VDS_VCO) 81 and the gate voltage (VGS_VCO) 83 are supplied to the first active component 82. As a result, the first active component 82 has a drain current of about 9.9 mA (9.902 mA) conducted therethrough.

A drain voltage (VDS_BUF) 91 for the second active component 92, which is an active component of the buffer amplifier 103, is set to be about 2.4V (2.472V) by the resistor R3 73, which is a resistor of the single bias circuit 50, and a gate voltage (VGS_BUF) 93 for the second active component 92 is set to be about −0.4V (−402.1 mV) by the resistor R4 74, which is a resistor of the single bias circuit 50. Then, the drain voltage (VDS_BUF) 91 and the gate voltage (VGS_BUF) 93 are supplied to the second active component 92. As a result, the second active component 92 has a drain current of about 16 mV (16.23 mV) conducted therethrough.

Through the experimental results described above, it can be seen that the single bias circuit designed in accordance with an embodiment of the present invention can supply an appropriate voltage and current to each active component constituting a multi-stage structure. In the multi-stage structure, an electrical current of a second stage can be set to be greater than that of a first stage in order to prevent performance degradation caused by current saturation.

While the present embodiment presents the single bias circuit 50 employed in the first local oscillating unit 105 of the microwave module 100 shown in FIGS. 3 to 5, it shall be apparent that the single bias circuit 50 can also be employed in the multi-stage amplifying unit 201 and the second local oscillating unit 204 of the RF module 200. Moreover, all the voltages being supplied to the microwave module 100 and the RF module 200 can be supplied by the single bias circuit 50 of the present invention. Furthermore, various voltages being supplied to a number of circuits constituting the radar detector can be supplied by the single bias circuit 50 of the present invention.

It is possible to form a simple circuit configuration since a multi-stage oscillator and a multi-stage amplifier having a single bias circuit in accordance with an embodiment of the present invention do not use a number of bias circuits. In other words, since the single bias circuit of the present invention is able to supply a voltage and an electric current required for each active component, not only is the circuit configuration simple, but also the circuit can be designed more simply in order for a low-cost circuit.

Furthermore, a small and low-cost radar detector having a multi-stage oscillator and a multi-stage amplifier, in which a single bias circuit of the present invention is employed, can be implemented by a simper circuit configuration, compared to the conventional technology.

While the spirit of the invention has been described in detail with reference to a certain embodiment, the embodiment is for illustrative purposes only and shall not limit the invention. It is to be appreciated that those skilled in the art can change or modify the embodiment without departing from the scope and spirit of the invention.

What is claimed is:

1. A radar detector comprising:
a microwave module configured to convert a UHF signal to an RF signal;
an RF module configured to convert the RF signal to an IF signal;
a demodulator configured to demodulate the IF signal; and
a signal processing controller configured to receive a signal demodulated by the demodulator and performs an appropriate control for each constituting component,
wherein the microwave module comprises:
an antenna configured to receive the UHF signal;
a first local oscillating unit comprising an oscillator and a buffer amplifier; and
a first mixing unit configured to convert a signal received from the antenna to the RF signal,
wherein the first local oscillating unit is supplied with power by a single bias circuit.

2. The radar detector of claim 1, wherein the RF module comprises:
a multi-stage amplifying unit having a single bias circuit for amplifying the RF signal;
a second mixing unit configured to convert the RF signal amplified by the multi-stage amplifying unit to an IF signal;
a second local oscillating unit configured to generate a frequency signal required for the second mixing unit; and
a filter configured to extract a specific band signal of the IF signal converted by the second mixing unit.

3. The radar detector of claim 2, wherein the multi-stage amplifying unit is constituted by at least two amplifiers, the amplifiers being supplied with a voltage by a single bias circuit.

4. The radar detector of claim 2, wherein at least one oscillator constituting the second local oscillating unit is supplied with a voltage by a single bias circuit.

5. The radar detector according to any one of claims 2 to 4, wherein the first local oscillating unit, the multi-stage amplifying unit and the second local oscillating unit are supplied with a voltage by a single bias circuit.

6. The radar detector of claim 5, wherein the single bias circuit comprises:
an external power source configured to be supplied with positive power and negative power from the outside;
a capacitor configured to remove noise generated by the external power source; and
a resistor.

7. The radar detector of claim 6, wherein some resistance among at least one resistor constituting the single bias circuit sets the positive power and the negative power supplied from the external power source as each respective voltage required for operation of the first local oscillating unit, the multi-stage amplifying unit and the second local oscillating unit.
